(19) United States
(12) Patent Application Publication
(10) Pub. No.: US 2007/0230001 A1
(43) Pub. Date: Oct. 4, 2007

(54) Head inspection apparatus and method thereof

(75) Inventors: Takahiro Imamura, Kawasaki (JP); Hiroyuki Kubotera, Kawasaki (JP); Toru Yokohata, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/481,067

(22) Filed: Jul. 6, 2006

(30) Foreign Application Priority Data
Mar. 30, 2006 (JP) 2006-096030

(51) Int. Cl. G11B 27/36

(52) U.S. Cl. 360/31

(57) ABSTRACT

In an inspection for judging acceptance of a recording and reproduction head used in a recording and reproduction device, quality information indicating quality of a data signal of a head unit and flying height information indicating flying height of the head unit are acquired, and acceptance of the head unit is judged by a combination of the quality and the flying height.

### BACKGROUND OF THE INVENTION

1. Field of the Invention

The present invention relates to an inspection apparatus for a recording and reproduction head in a recording and reproduction device, such as a magnetic disk device.

2. Description of the Related Art

In an inspection for judging the quality of a magnetic head in a magnetic disk device, there is a flying height test (FHT) that examines whether a flying height of the head meets a predetermined standard and a head test (HT) that examines whether quality of reading and writing of data meets a predetermined standard (for example, refer to Patent Reference 1, below). In a conventional head inspection, the FHT and the HT are separate procedures and respectively have independent acceptance criteria.

In the FHT, acceptance is decided by whether the flying height exceeds a standard value. In the HT, acceptance is decided by whether signal-to-noise ratio (S/N) exceeds a standard value or whether error rate is below a standard value. One head is required to meet the criteria of both tests to be ultimately judged acceptable.

For example, when S/N is used as a measure for the HT, as shown in FIG. 1, the inspected head is judged to be acceptable if the flying height FH is equal to or more than a standard value H0 and S/N is equal to or more than a standard value R0.

In recent years, a technology is being put into practical use, in which a flying height control actuator having a microheater provided near an element within a head slider is installed in a head gimbal assembly (HGA) and the flying height of the head slider that is in operation is controlled (for example, refer to Patent Reference 2 and Patent Reference 3, below).

Patent Reference 1: Japan Laid-open Patent Application No. 06-020236

Patent Reference 2: Japan Laid-open Patent Application No. 05-020635

Patent Reference 3: Japan Laid-open Patent Application No. 2004-259323

The flying height control actuator causes a magnetic pole tip unit to protrude by heat expansion by energizing the heater and causing it to produce heat, thereby reducing the flying height.

As a general usage of a head, such as the above, manufacturing is performed according to conditions in which a flying height position is the lowest, among variations in the flying height caused by conditions, such as inner and outer circumference positions of a disk and ambient temperature. In conditions in which the flying height position becomes higher than the above, the flying height control actuator performs control to lower the flying height.

The conventional head inspection method described above has the following problems.

In a magnetic disk device including the flying height control actuator, S/N generally tends to rise because the flying height during actual use is low, compared to the flying height measured at a normal temperature and when de-energized, and signal-strength increases. When the same conventional inspection standards are applied to a head inspection such as the above, instances occur in which heads that can essentially be used as acceptable products are judged to be defective.

Therefore, to enhance inspection yield, inspection standards differing from the conventional standards are required.

### SUMMARY OF THE INVENTION

An object of the present invention is to enhance inspection yield of a recording and reproduction head used in a recording and reproduction device in which flying height control is possible.

The head inspection apparatus of the present invention includes an acquiring device and a judging device, and judges acceptance of the recording and reproduction head used in the recording and reproduction device. The acquiring device acquires quality information indicating the quality of a data signal of a head unit and flying height information indicating the flying height of the head unit. The judging device judges the acceptance of the head unit by a combination of the quality and the flying height.

### BRIEF DESCRIPTION OF THE DRAWINGS

FIG. 1 is a diagram showing a conventional head inspection method;

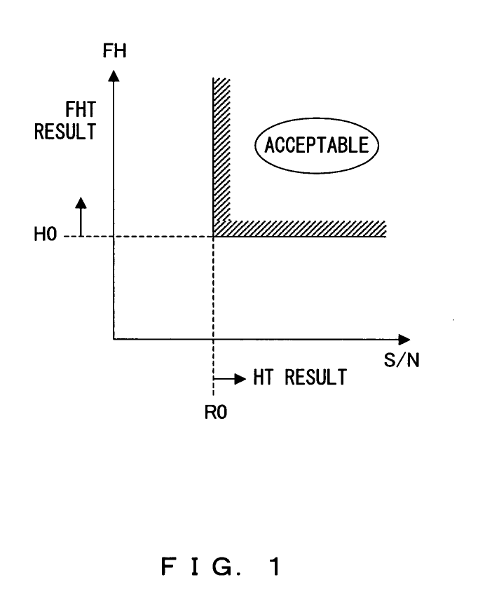

FIG. 2 is a principle diagram of a head inspection apparatus according to the present invention;

FIG. 3A is a diagram showing a head inspection method of the present invention;

FIG. 3B is a flowchart of an acceptance judgment;

FIG. 4 is a block diagram of a first head inspection apparatus;

FIG. 5 is a block diagram of a second head inspection apparatus;

FIG. 6 is a block diagram of a third head inspection apparatus;

FIG. 7 is a diagram showing a detailed example of the head inspection apparatus; and

FIG. 8 is a block diagram of a head unit.

### DESCRIPTION OF THE PREFERRED EMBODIMENT

Hereinafter, preferred embodiments of the present invention are described in detail, with reference to the accompanying drawings.

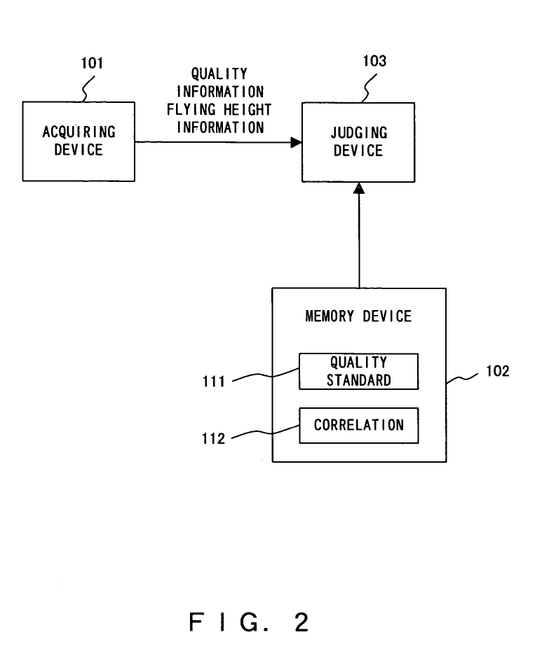

FIG. 2 is a principle diagram of a first and second head inspection apparatus according to the present invention.

The first head inspection apparatus according to the present invention includes an acquiring device 101 and a judging device 103, and judges acceptance of a recording and reproduction head used in a recording and reproduction device.

The acquiring device 101 acquires quality information indicating the quality of a data signal of a head unit and flying height information indicating the flying height of the head unit. The judging device 103 judges the acceptance of the head unit by a combination of the quality and the flying height.

The second head inspection apparatus according to the present invention includes the acquiring device 101, a memory device 102, and the judging device 103, and judges the acceptance of the recording and reproduction head used in the recording and reproduction device.

The acquiring device 101 acquires the quality information indicating the quality of the data signal of the head unit and flying height information indicating the flying height of the head unit. The memory device 102 stores a quality standard 111 and a quality and flying height correlation 112. When quality information does not meet the quality standard 111, the judging device 103 judges the head unit to be acceptable if the flying height information meets a judging condition, in which the flying height is equal to or more than a flying height determined from the quality information and the correlation 112.

The acquiring device 101 transfers the quality information, indicating the quality of the data signal of the head unit, and the flying height information, indicating the flying height of the head unit, to the judging device 103. The judging device 103 first extracts the quality standard 111 from the memory device 102 and checks whether the quality information meets the quality standard 111.

If the quality information does not meet the quality standard 111, next, the judging device 103 extracts the correlation 112 from the memory device 102 and determines the flying height corresponding to the quality information using the correlation 112. Then, the judging device 103 compares the flying height indicated by the flying height information with the flying height information obtained from the correlation 112 and judges the head unit to be acceptable if the former flying height is equal to or more than the latter flying height.

According to a judging method such as the above, a part of head units that failed the conventional inspection due to not meeting the quality standard 111 can be judged to be acceptable, thereby enhancing the inspection yield.

The head unit that is judged to be acceptable has a flying height equal to or more than a value determined by the correlation 112, and a margin is present between this flying height and a standard value of the flying height. Therefore, after the head unit is installed in the recording and reproduction device, the flying height can be lowered by a flying height control actuator or the like, and the head unit can be used with enhanced data signal quality.

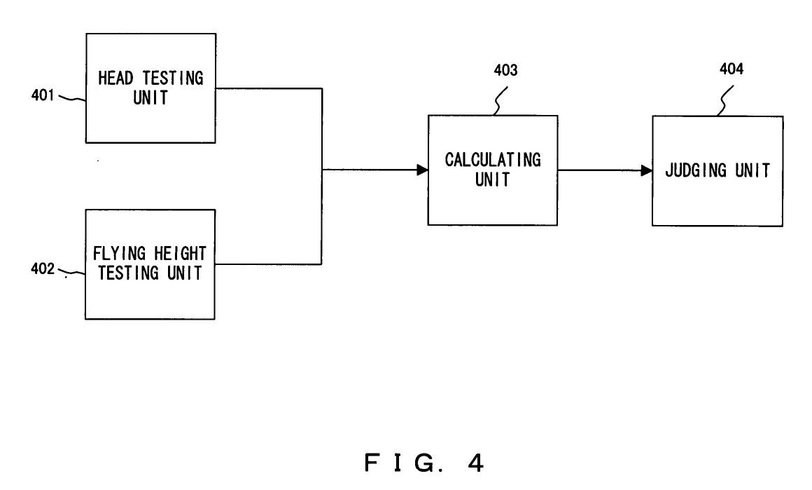

For example, in the head inspection apparatus in FIG. 4, the acquiring device 101 corresponds to a head testing unit 401 and a flying height testing unit 402. The judging device 103 corresponds to a calculating unit 403 and a judging unit 404.

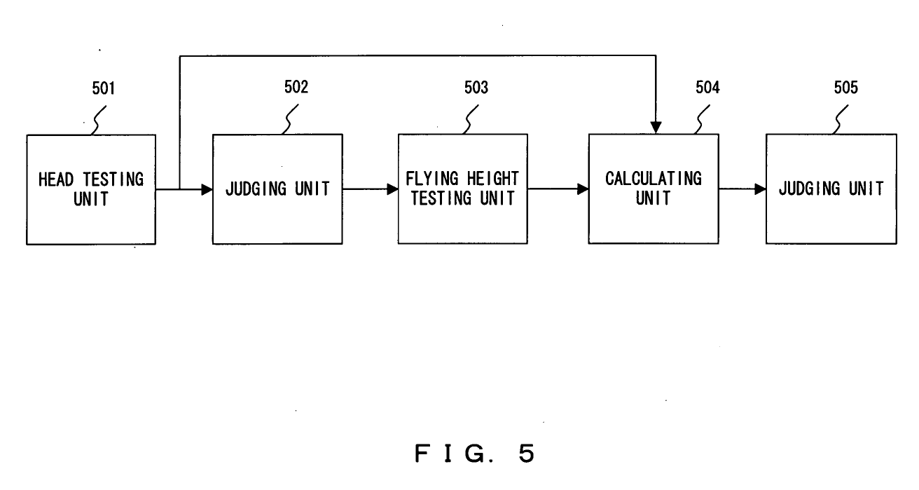

In addition, in the head inspection apparatus in FIG. 5, the acquiring device 101 corresponds to a head testing unit 501 and a flying height testing unit 503. The judging device 103 corresponds to a calculating unit 504 and a judging unit 505.

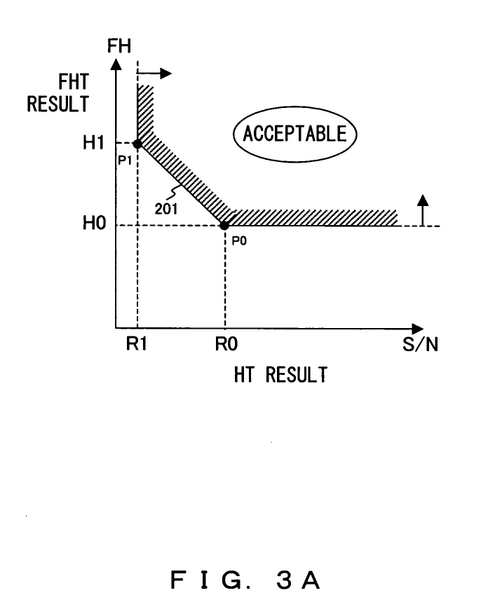

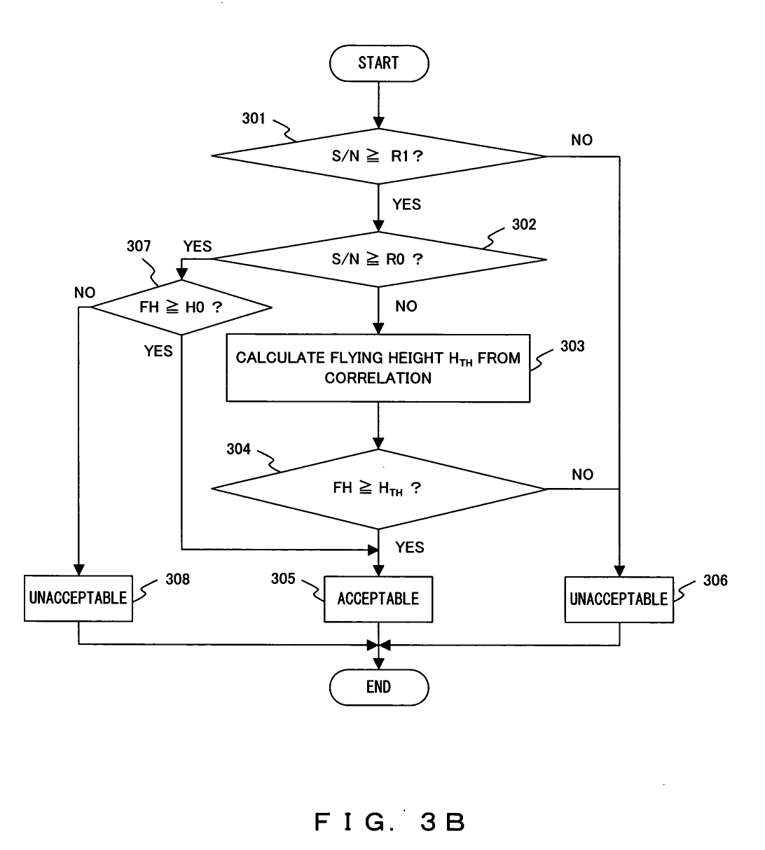

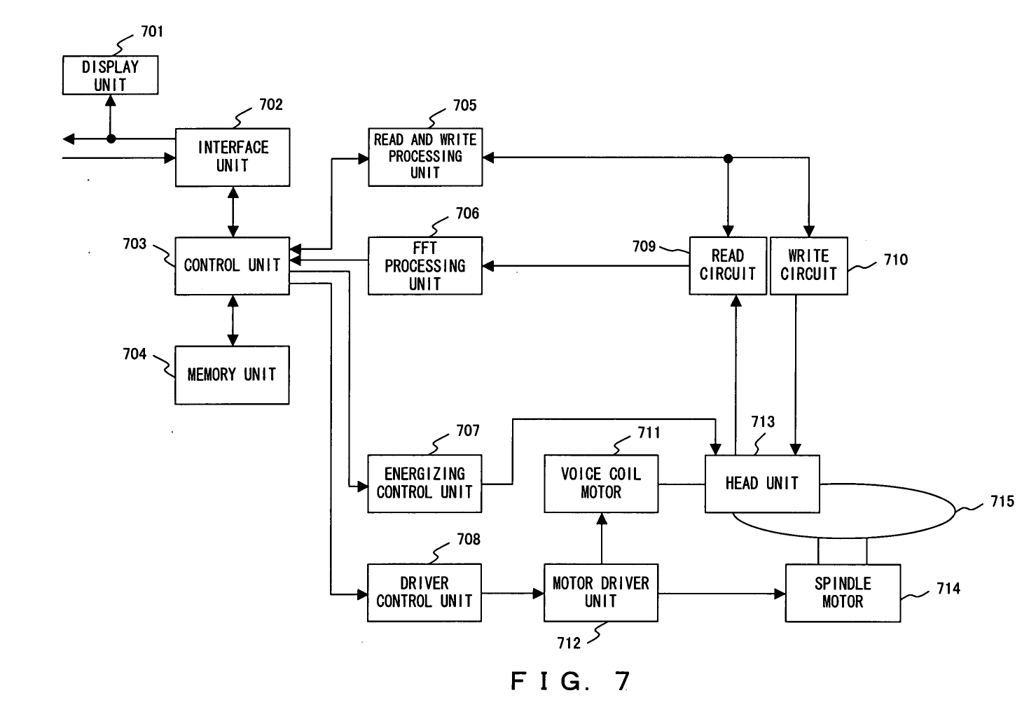

The memory device 102 corresponds to, for example, a memory unit 704 in FIG. 7. The quality standard 111 corresponds to, for example, a standard value R0 in FIG. 3A. The correlation 112 corresponds to, for example, a straight line 201 in FIG. 3A.

According to the present invention, the inspection yield can be enhanced by the performance of acceptance judgment taking into consideration results of both the FHT and the HT.

Even when a head has a low S/N value in the HT, the head can be used by lowering the flying height through the introduction of a flying height control technology and raising the S/N ratio, if the S/N is low due to the flying position being too high. Therefore, if the acceptance judgment is performed taking into consideration both HT measurement results and FHT measurement results, judgment of a head, that should essentially be acceptable, to be unacceptable can be prevented.

As shown in FIG. 3A, the head inspection apparatus according to the present embodiment judges a head that has a low S/N due to a high flying height measured by the FHT, among the heads having low S/N in the HT, to be acceptable under the judgment conditions according to S/N. Generally, it is known that the flying height and the S/N (dB) approximately have a linear relationship. The final acceptance can be determined by a predetermined calculation using the values of the S/N (dB), that is the HT measurement result, and the flying height FH (nm), that is the FHT measurement result.

When the horizontal axis in FIG. 3A is S/N and the vertical axis is FH, the straight line 201 on a two-dimensional plane expresses the correlation between the S/N and the FH and is defined as a straight line passing through point P0. The coordinate of P0 is (R0, H0) R0 and H0 respectively express the standard values of the S/N and the FH.

The coordinate of point P1 is (R1, H1). H1-H0 corresponds to a variable stroke of the FH by the flying height control actuator. R0-R1 expresses a variable range of the S/N corresponding to the variable stroke.

First, with regards to a region in which the S/N of the head is equal to or more than the standard value R0, the head is judged to be acceptable if the flying height FH is equal to or more than the standard value H0, as is conventionally. Next, with regards to a region in which the S/N is under the standard value R0, the acceptance judgment is performed divided into instances, such as the following:

(1) S/N<R1 unacceptable

(2) R1≦S/N<R0

(a) A region above the straight line 201 and the points on the straight line 201 are acceptable. Here, the straight line 201 is expressed by the following equation:
FH=A·(S/N)+B
A=−(H1−H0)/(R0−R1)
B=H0+[(H1−H0)/(R0−R1)]·R0 (1)

Therefore, a head is judged to be acceptable if the (S/N, FH) meet the following inequality:
FH≧A·(S/N)+B (2)

(b) A region below the straight line 201 is unacceptable.

Therefore, a head is judged to be acceptable if the (S/N, FH) meet the following inequality:
FH<A·(S/N)+B (3)

FIG. 3B is a flowchart of the acceptance judgment in FIG. 3A. The head inspection apparatus first compares the S/N value measured in HT with R1 (Step 301) and judges the head to be unacceptable if S/N<R1 (Step 306).

If S/N≧R1, the head inspection apparatus then compares the S/N value with R0 (Step 302). If S/N≧R0, the head inspection apparatus judges that the quality standards are met and then compares the FH value measured in the FHT with H0 (Step 307). If FH≧H0, the head is judged to be acceptable (Step 305). If FH<H0, the head is judged to be unacceptable (Step 308).

If S/N<R0 in Step 302, the head inspection apparatus judges that the quality standards are not met and calculates the flying height H_{TH} corresponding to the S/N value, using the equation (1) (Step 303). Then, the head inspection apparatus compares the FH value with H_{TH} (Step 304). If FH≧H_{TH}, the head is judged to be acceptable (Step 305). If FH<H_{TH}, the head is judged to be unacceptable (Step 306).

In a judgment method such as this, a part of the heads in an R1≦S/N<R0 region that were rejected in the conventional head inspection can be judged to be acceptable, thereby enhancing inspection yield. As the correlation between S/N and H_{TH}, an equation of a predetermined curved line can be used in place of the equation of the straight line 201. As the measurement result of HT, other quality information, such as the error rate ER, can be used in place of S/N. Logarithm of the error rate ER, log₁₀(ER) can generally be handled as a value of a reciprocal of S/N multiplied by a predetermined coefficient. Therefore, the same acceptance judgment as in FIG. 3B can be made.

FIG. 4 shows a configuration example of a head inspection apparatus that performs an acceptance judgment such as that above. The head inspection apparatus includes a head testing unit 401, a flying height testing unit 402, a calculating unit 403, and a judging unit 404.

The head testing unit 401 measures S/N of the head. The flying height testing unit 402 measures the flying height FH of the head. The calculating unit 403 uses the measurement results and, for example, performs the processes at Steps 301 to 303 in FIG. 3B. The judging unit 404, for example, performs the processes at Step 304 to 308 in FIG. 3B and outputs a judgment result. The error rate ER can be measured and −log₁₀(ER) can be used in place of S/N.

FIG. 5 shows a configuration example of another head inspection apparatus. The head inspection apparatus includes a head testing unit 501, judging units 502 and 505, a flying head testing unit 503, and a calculating unit 504. The head inspection apparatus performs the HT prior to the FHT, and performs a preliminary judgment using the result.

In the conventional head inspection, in general, inspection yields in which the flying height in the FHT are equal to or more than a standard value is comparatively high. On the other hand, inspection yields in the HT tends to be lower than in FHT, because there are heads in which an output level of a signal is significantly low or heads that are rejected due to items, such as waveform distortion. By the performance of the preliminary judgment by the HT being performed before the FHT, the number of overall testing procedures can be reduced.

Operations of the head testing unit 501 and the judging unit 505 are the same as the operations of the head testing unit 401 and the judging unit 404 in FIG. 4. The judging unit 502 uses the measurement result from the head testing unit 501, performs the judgment (preliminary judgment) at Step 301 in FIG. 3B, and outputs the judgment result with the measurement result. In the preliminary judgment, for example, only the heads which are S/N≧R1 are selected as the targets of the FHT. The flying height testing unit 503 measures the flying height FH of the selected heads.

The calculating unit 504 uses the measurement result from the head testing unit 501, performs the processes at Steps 302 and 303 in FIG. 3B, and calculate the flying height H_{TH} of the head that is S/N<R0. Then, the calculating unit 504 outputs the measurement result from the flying height testing unit 503 and the obtained flying height H_{TH} value to the judging unit 505.

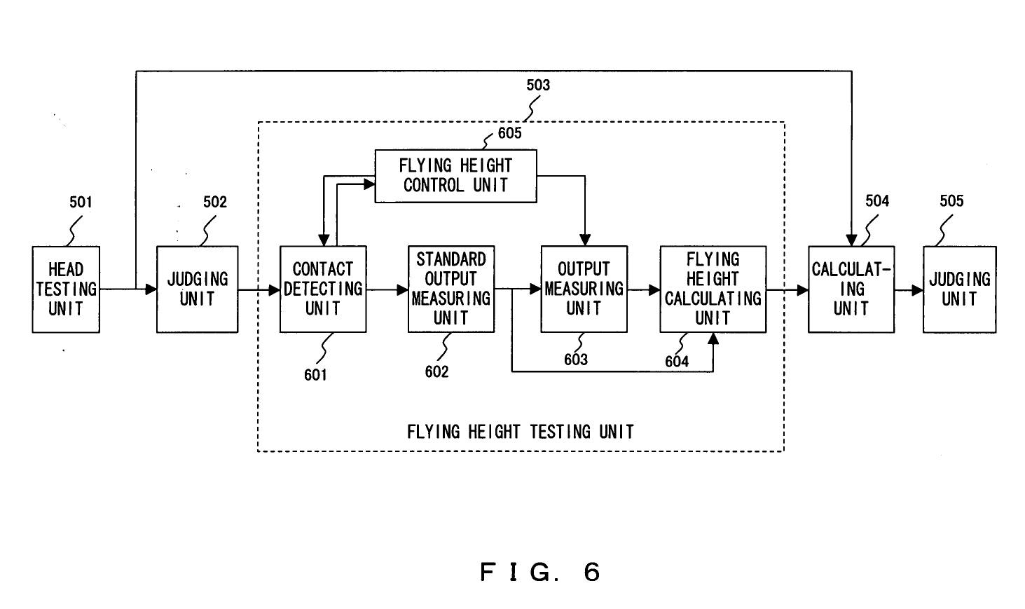

FIG. 6 shows a configuration example of the flying height testing unit 503 in the head inspection apparatus in FIG. 5. The flying height testing unit 503 includes a contact detecting unit 601, a reference output measuring unit 602, an output measuring unit 603, a flying height calculating unit 604, and a flying height control unit 605.

In the conventional FHT, the flying height is generally measured by an optical method, by flying a head slider over a transparent glass disk and irradiating a laser beam or the like onto the opposite surface of the glass disk. To ensure transparency, the glass disk does not have a magnetic film for recording, and therefore, reading and writing of signals cannot be performed.

As described above, the conventional FHT and HT are independent inspections and there was no particularly strong reason to perform the inspections using the same disk. However, when a magnetic measuring method is used in place of the optical measuring method in the FHT, the HT and the FHT can be performed with one spindle motor. This is preferable from the perspectives of the amount of hardware and the number of testing procedures.

The magnetic measuring method can be performed under the following concept, using a magnetic disk that has a magnetic film as a recording medium.

Generally, reproduction output of the magnetic disk device tends to become larger as the flying height becomes lower. It is known that a certain correlation exists between the reproduction output and the flying height. Therefore, if the output level at a reference flying height is known, a flying height forcibly set to a different value can be determined by calculation from the changes in the output level.

Here, if the output level at the reference flying height H_{ref} is V_{ref}, the flying height FH when the output level is V can be calculated by the following equation, using coefficient C.
FH=H_{ref}+C·ln(V_{ref}/V) (4)

First, the flying height control unit 605 activates the contact detecting unit 601 and gradually lowers the flying height of the head. Then, when the contact detecting unit 601 detects contact between the head and the magnetic disk, the flying height control unit 605 returns the flying height to a slightly high predetermined value. This value is equivalent to the reference flying height H_{ref}. The reference output measuring unit 602 measures the output level at this time and outputs the measured output level as the reference output V_{ref}.

The flying height control unit 605 can lower the flying height by reducing disk revolution or by decompressing the testing environment. Furthermore, the flying height control unit 605 can lower the flying height by operating the flying height control actuator provided somewhere within the HGA. The reference flying height H_{ref} is presumed to be known in advance by a magnetic disk inspection or the like.

Next, the flying height control unit 605 stops the contact detecting unit 601 and releases the flying height control. In this state, the output measuring unit measures the output level. The flying height calculating unit 604 calculates the flying height FH according to equation (4), from the reference flying height H_{ref}, the reference output V_{ref}, and the measured value V of the output measuring unit 603. The FH value is outputted to the calculating unit 504 as the measurement result of the flying height testing unit 503.

FIG. 7 shows a detailed example of the head inspection apparatus in FIG. 6 that includes the flying height testing unit 503, such as that above. The head testing device in FIG. 4 can be actualized by the same configuration.

The head inspection apparatus in FIG. 7 includes a display unit 701, an interface unit 702, a control unit 703, a memory unit 704, a read and write processing unit 705, a fast Fourier transform (FFT) processing unit 706, an energizing control unit 707, a driver control unit 708, a read circuit 709, a write circuit 710, a voice coil motor 711, a motor driver unit 712, a spindle motor 714, and a magnetic disk 715. The head inspection apparatus performs an inspection of a head unit 713.

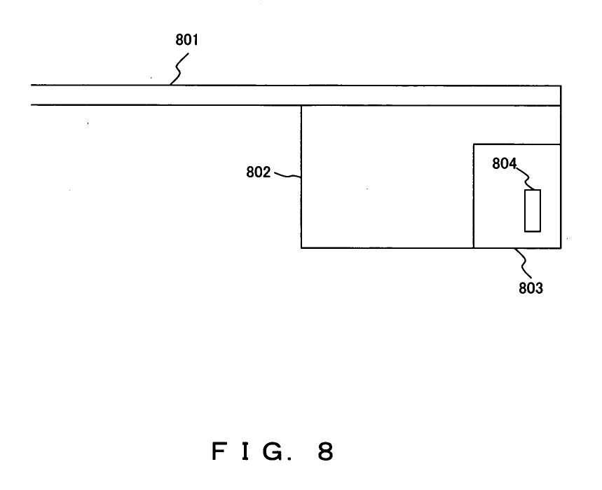

The head unit 713 corresponds, for example, to the HGA and includes a suspension 801 and a head slider 802, as shown in FIG. 8. A magnetic head 803 within the head slider 802 includes a flying height control actuator 804. The flying height control actuator 804 includes, for example, a heater. The flying height control actuator 804 heats up when an electric current is applied and causes heat expansion of a magnetic pole tip. As a result, the flying height of the magnetic head 803 is lowered. A piezoelectric element or the like can be used in place of the heater.

The control unit 703 controls the overall head inspection apparatus and achieves the functions of the judging unit 502 and 505 and the calculating unit 504 by outputting control signals to the read and write processing unit 705, the energizing control unit 707, and the driver control unit 708.

The driver control unit 708 controls the motor driver unit 712. The motor driver unit 712 drives the voice coil motor 711 and the spindle motor 714. The magnetic disk 715 is rotated by the spindle motor 714. The head unit 713 moves to an arbitrary position on the magnetic disk 715 by the voice coil motor 711.

The read and write processing unit 705 outputs write data according to an instruction from the control unit 703. The write circuit 710 writes the write data to the magnetic disk 715, via the head unit 713. The read circuit 709 reads out data from the magnetic disk 715, via the head unit 713 and outputs the data to the read and write processing unit 705 and the FFT processing unit 706 as read signals.

The read and write processing unit 705 outputs the read signals to the control unit 703 as read data. The FFT processing unit 706 executes a fast Fourier transform using the read signals, extracts a signal level of a predetermined frequency component, and outputs the signal level to the control unit 703. The energizing control unit 707 adjusts the electric current supplied to the head unit 713 according to an instruction from the control unit 703.

The memory unit 704 stores the standard value R0 and threshold value R1 of S/N, the standard value H0 of the flying height, the correlation between S/N and the flying height, the correlation between the reproduction output and the flying height, the measurement results of S/N and the flying height, and the like. When the function log₁₀(ER) of the error rate ER is used as the quality information, a standard value and a threshold value of the log₁₀(ER), a correlation between the log₁₀(ER) and the flying height, and a measurement result of the log₁₀(ER) are also stored.

The control unit 703 can receive information required for control from an external device (a computer or the like), via an interface unit 702, and can transmit the measurement results and the judgment results to the external device, via the interface unit 702. The display unit 701 displays the measurement results and the judgment results outputted from the control unit 703 on a screen as the inspection results.

All or a portion of the functions of the display unit 701, the interface unit 702, the control unit 703, the memory unit 704, the read and write processing unit 705, the FFT processing unit 706, the energizing control unit 707, and the driver control unit 708 can be actualized using a computer. In this case, the memory unit 704 corresponds to a memory or the like. Each function of the control unit 703, the read and write processing unit 705, the FFT processing unit 706, the energizing control unit 707, and the driver control unit 708 is actualized by a program stored in the memory unit 704. A central processing unit (CPU) (not shown) performs the head inspection by executing the program.

Next, the operations of the head inspection apparatus in the respective tests, HT and FHT, are explained. In the explanation below, S/N is used as a measurement subject in the HT, and a signal pattern including a predetermined frequency component is stored in the magnetic disk 715, in advance.

First, in the HT, the control unit 703 tries reading and writing of data, via the read and write processing unit 705, and measures S/N of the read data signal. Then, the judgment at Step 301 in FIG. 3B is performed using the obtained S/N value.

Next, in the FHT, the control unit 703 functions as the contact detecting unit 601, the flying height calculating unit 604, and the flying height control unit 605, and measures the flying height FH, with only the head units 713 that are S/N≧R1 as targets.

The control unit 703 gradually reduces the revolution of the spindle motor 714, via the driver control unit 708 and the motor driver unit 712, thereby reducing the rotation speed of the magnetic disk 715. As a result, the flying height of the head unit 713 is lowered and the magnetic pole tip of the head unit 713 approaches the magnetic disk 715.

During this time, the control unit 703 monitors the amplitude of the predetermined frequency component (primary frequency component) outputted from the FFT processing unit 706. When the amplitude decreases rapidly with a larger shift than a threshold value, or when the amplitude is below a threshold value, the control unit 703 judges that the head unit 703 is in contact with the magnetic disk 715. Then, the control unit 703 increases the revolution slightly, returns the flying height to the reference flying height H_{ref}, and measures the reference output V_{ref} from the output signals of the read and write processing unit 705 or the FFT processing unit 706.

Next, the control unit 703 increases the revolution to a value for the FHT, measures the output V from the output signals from the read and write processing unit 705 or the FFT processing unit 706, and calculates the flying height FH according to equation (4).

In place of reducing the rotation speed of the magnetic disk 715, the flying height can be reduced by the flying height control actuator 804 of the head unit 713 being operated. In this case, the control unit 703 detects the contact between the head unit 713 and the magnetic disk 715 by supplying electric current to the head unit 713, via the energizing control unit 707, while monitoring the output signals of the FFT processing unit 706. Then, the control unit 703 measures the output V after the electric current supply has stopped and calculates the flying height FH. Furthermore, rotation speed control and control by the flying height control actuator 804 can be used in combination.

Next, the control unit 703 performs the processes at Steps 302 to 308 in FIG. 3B, using S/N measured in the HT and the FH measured in the FHT, and outputs the judgment result to the display unit 701.

In the explanation above, contact is detected in the FHT by the signal of the predetermined frequency component being read out from the magnetic disk 715. However, it is not limited thereto and other contact detecting methods can also be used. For example, the reproduction output from the read and write processing unit 705 can be monitored and contact can be detected when the shift in the reproduction output is less than a minute value.

In addition, another measuring method can be implemented, rather than the determination of the flying height FH from the level of the reproduction output. For example, the signal levels of two certain differing frequency components can be extracted by the FFT processing unit 706 and the flying height FH can be determined from the ratio of their amplitudes.

In this case, a signal pattern including two frequency components (for example a primary component and a third-order harmonic component) is written to the magnetic disk 715 in advance. The FFT processing unit 706 outputs the amplitudes of respective frequency components to the control unit 703. Then, the control unit 703 calculates the flying height FH by the following equation from the primary component amplitude V1 and the third-order harmonic component amplitude V3.
FH=D·ln((V1/V3)/(V1_{ref}/V3_{ref}))+E (5)
Coefficient D in the equation (5) is determined in advance. Constant E is determined from the respective frequency component amplitudes V1_{ref} and V3_{ref}, at the reference flying height H_{ref}.

In addition, the FFT can be replaced with a discrete Fourier transform (DFT).

Although the head inspection of the magnetic disk device is explained in the embodiment described above, the present invention is not limited thereto and can be applied to the head inspection of other recording and reproduction devices, such as an optical disk device, and a magneto-optical disk device.

What is claimed is:

1. A head inspection apparatus that judges acceptance of a recording and reproduction head used in a recording and reproduction device, comprising:
an acquiring device that acquires quality information indicating quality of a data signal of a head unit and flying height information indicating flying height of the head unit; and
a judging device that judges acceptance of the head unit by a combination of the quality and the flying height.

2. The head inspection apparatus according to claim 1, comprising a memory device that stores a quality standard and a correlation between quality and flying height;
wherein, when the quality information does not meet the quality standard, the judging device judges the head unit to be acceptable if the flying height information meets a judgment condition, in which the flying height of the head unit is equal to or more than flying height determined by the quality information and the correlation.

3. The head inspection apparatus according to claim 2, wherein the judging device judges the head unit to be unacceptable when the quality information is less than a threshold and checks whether the quality information meets the quality standard when the quality information is equal to or more than the threshold value.

4. The head inspection apparatus according to claim 1, wherein the acquiring device includes a quality measuring device that measures the quality of the data signal outputted from the head unit, and a flying height measuring device that measures the flying height of the head unit.

5. The head inspection apparatus according to claim 4, further comprising a rotation device that rotates a recording medium,
wherein the quality measuring device and the flying height measuring device share the rotation device and perform measurement of the quality of the data signal and the measurement of the flying height.

6. The head inspection apparatus according to claim 4, wherein the flying height measuring device measures the flying height of the head unit based on a reproduction signal from the recording medium.

7. The head inspection apparatus according to claim 6, wherein the flying height measuring device calculates the flying height of the head unit from a reference output, when the head unit contacts the recording medium, and an output, when the head unit is flying over the recording medium.

8. The head inspection apparatus according to claim 7, wherein the head unit includes a flying height control actuator device that changes the flying height of the head unit, and the flying height measuring device detects contact between the head unit and the recording medium by operating the flying height control actuator device and reducing the flying height of the head unit.

9. A head inspection method of judging acceptance of a recording and reproduction head used in a recording and reproduction device, comprising:
acquiring quality information indicating quality of a data signal of a head unit;
acquiring flying height information indicating flying height of the head unit; and
judging acceptance of the head unit by a combination of the quality and the flying height.

10. The head inspection method according to claim 9, wherein:
said acquiring quality information acquires the quality information by measuring the quality of the data signal of the head unit;
said acquiring flying height information acquires the flying height information by measuring the flying height of the head unit; and
said judging refers to a quality standard and a correlation between quality and flying height, and when the quality information does not meet the quality standard, judges the head unit to be acceptable if the flying height information meets a judgment condition, in which the flying height of the head unit is equal to or more than flying height determined by the quality information and the correlation.

11. The head inspection method according to claim 10, wherein said measuring the quality of the data signal and said measuring the flying height are performed consecutively by sharing a rotation device that rotates a recording medium.

12. A head inspection apparatus that judges acceptance of a recording and reproduction head used in a recording and reproduction device, comprising:
acquiring means for acquiring quality information indicating quality of a data signal of a head unit and flying height information indicating flying height of the head unit; and
judging means for judging acceptance of the head unit by a combination of the quality and the flying height.
